(19) United States
(12) Patent Application Publication
(10) Pub. No.: US 2006/0066005 A1
(43) Pub. Date: Mar. 30, 2006

(54) Method and apparatus for producing dope and solution casting method

(75) Inventor: Hiromasa Tanaka, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/232,935

(22) Filed: Sep. 23, 2005

(30) Foreign Application Priority Data
Sep. 24, 2004 (JP) 2004-277173

(51) Int. Cl. B29C 39/14; B29B 7/00

(52) U.S. Cl. 264/216; 264/349; 366/181.5

(57) ABSTRACT

An additive is fed in a tube which is connected to a pipe for feeding a polymer solution, and a nozzle is provided in a front end of the tube. On a front end of the nozzle, a slit like slit is formed so as to extend in a diameter direction of the pipe. The front end is almost perpendicular to an upstream end of the nearest element of a static mixer. When the additive is added to the polymer solution through the slit, the additive is separated enough from a forward side of the static mixer, and the addition is made without rotation of the additive. Thus the mixing and stirring of the polymer solution and the additive is effectively made.

### BACKGROUND OF THE INVENTION

1. Field of the Invention

The present invention relates to a method and an apparatus for producing a dope, particularly to a method and an apparatus for producing a dope from which a polymer film for optical use, such as in a liquid crystal display and the like, is formed, and a solution casting method with use of the dope produced by the method and the apparatus.

2. Description Related to the Prior Art

There are several sorts of polymer film for optical use. Especially, a cellulose acylate film is one of the widely used polymer films, since it has transparency and adequate moisture permeability, large mechanical strength, and low temperature- and moisture-dependence of dimensional stability.

The liquid crystal display includes a polarizing filter and an optical compensation film. The polarizing filter usually has a protective film on both surface of a polarized film. In recent years, the optical compensation film is superseded by the protective film. If the cellulose acylate film is provided with many optical properties, this film can simultaneously has both effects of the protective film and the optical compensation film.

Otherwise, the demand of the liquid crystal display increases as displaying device of a liquid crystal television, and a higher brightness, a bigger screen, and a higher-quality picture are required for the liquid crystal display. In such an extended definition television, even slight mixing unevenness of additives has large bad influences on displaying.

The cellulose acylate film is often formed by a solution casting method. In order to form the cellulose acylate film, polymer is mixed to a solvent to prepare a polymer solution and several sorts of additive compounds (such as UV absorbing agent, matting agent, retardation controller and the like) are added to the polymer solution. Thus a dope is obtained, and cast from a casting die onto a casting support. When the cast dope has self-supporting property, it is peeled as a film from the support, and thereafter dried. The support may be a drum or belt that is continuously running.

In a dope production, the additive containing several additive compounds is added to the polymer solution just before the casting die, and mixed by a motionless mixer (static mixer). When a material is fed into a pipe in which the static mixer is disposed, a flux of the material is separated into plural fluxes, and a rotation of each flux is performed such that the flux direction may be changed. Then the separation and the rotation are repeated to make the mixing.

The representative static mixer is Static Mixer TM (produced by Kenics Co.). The static mixer has a first element for rotating the flux in a first direction perpendicularly to a feed direction of the material and a second element for rotating the flux in a second direction opposite to the first direction. These elements are arranged in the feeding direction with angular difference at 90° and in each element, the flux of the fed material is separated into two fluxes. When the first element rotates, the fluxes are rotated at 180° in the first direction, and when the second element rotates, the fluxes are rotated at 180° in the second direction. When the mixture of the polymer solution and the additives is fed into the static mixer, the stirring of the mixture is continuously made.

If the stirring is not enough, the quality of the production becomes lower. Therefore, in order to make the stirring enough, several technological developments are made. For example, Japanese Patent Laid-Open Publication No. 2005-48103 proposes a method for producing a uniform dope, in which a heating condition of the static mixer and the pressure of the dope are controlled such that the temperature distribution, namely, a temperature non-uniformity, of the dope may be reduced. Further in Japanese Patent Laid-Open Publication No. 2003-53752 discloses an embodiment in which an orifice of the additive is disposed close to the static mixer.

However, in the methods of the prior arts, the stirring cannot be performed ecciciently. Namely, since the additive is added from a cylindrical addition nozzle disposed nearly in a middle of a pipe in which the polymer solution is fed, it takes long time that the additives spread from the center to an inner wall of the pipe. Therefore, in order to perform the stirring enough, the static mixer to be used has many elements, which causes a large processing system and high cost.

### SUMMARY OF THE INVENTION

An object of the present invention is to provide a method and an apparatus for producing a dope, in which the stirring is made effectively.

Another object of the present invention is to provide a solution casting method of forming from the dope a polymer film used for displaying the high-quality image.

In order to achieve the object and the other object, in a method of producing a dope of the present invention, a polymer is dissolved to a solvent such as a polymer solution is obtained passed through a pipe. Then an additive is added to the polymer solution through a slit disposed in the pipe. The slit extends in a diameter direction of the pipe. A mixture of the polymer solution and the additive is mixed and stirred by an inline mixer, such that the dope may be obtained.

Preferably, a length of the slit is in the range of 20% to 80% of an inner diameter of the pipe. Further, a clearance of the additive is in the range of 0.1 mm to 1/10 of an inner diameter of the pipe. A distance of the slit to the inline mixer is in the range of 1 mm to 250 mm. When a flow velocity of the additive is V1 and a flow velocity of the polymer solution is V2, a condition of 1≦V1/V2≦5 is satisfied.

Furthermore, the polymer solution has a viscosity in the range of 5000 cp to 500000 cp at 20° C., a shearing rate V3 of the polymer solution satisfies a condition of 0.1 (1/s)≦V3≦30(1/s), a Reynolds number of the polymer solution is at most 200, and the additive has a viscosity in the range of 0.1 cp to 100 cp. Furthermore, an addition ratio of the additive is from 0.15 to 50% in flow volume.

In a solution casting method of the present invention, a polymer is dissolved to a solvent such as a polymer solution is obtained fed in a pipe. Then an additive is added to the polymer solution through a slit disposed in the pipe. The slit extends in a diameter direction of the pipe. A mixture of the polymer solution and the additive is mixed and stirred by an inline mixer, such that the dope may be obtained. The dope is cast on a support so as to form a polymer film.

An apparatus for producing a dope of the present invention includes a pipe for passing a polymer solution through which a polymer is dissolved to a solvent, an addition nozzle disposed in the pipe for feeding the additive out to the polymer solution and extending in a diameter direction of the pipe, and an inline mixer. An additive is fed through the tube and added through the slit. The inline mixer mixes the polymer solution and the additive, such that the dope may be obtained.

Preferably, the inline mixer is a static mixer which has an element formed by wrenching a rectangle plate, and a lengthwise direction of the slit is almost perpendicular to an upstream end of the element.

The film produced by the solution casting method of the present invention may construct a protective film for a polarizing filter and a film base of a photo film. Further, the film may be used as an optical compensation film for improving a view angle dependence of the liquid crystal display for a TV monitor. Especially, the film is effectively used for doubling as protective film for the polarizing filter. Therefore, the film can not be used for only TN mode, but also IPS mode, OCB mode, VA mode and the like. Further, the polarizing filter may be constructed with use of the protective film for the polarizing filter.

According to the present invention, the additive is added through the slit-like orifice extending in the diameter direction of the tube in which the polymer solution flows. Therefore, the mixing and stirring of a mixture of the additive and the polymer solution is efficiently made in the inline mixer. Consequently, a number of the elements in the inline mixer may be smaller. Thus the size of the production process becomes smaller and the cost becomes lower.

Further, the mixing and stirring of the additive and the polymer solution is efficiently made, and the obtained dope is uniform. Therefore, when the dope is used in the solution casting method, the produced film is used for the protective film for the polarizer, the optical compensation film and the film base. Thus the product has high quality.

### BRIEF DESCRIPTION OF THE DRAWINGS

The above objects and advantages of the present invention will become easily understood by one of ordinary skill in the art when the following detailed description would be read in connection with the accompanying drawings:

FIG. 1 is an explanatory view of a dope production line;

FIG. 2 is an explanatory view of a film production line;

FIG. 3 is a sectional view of a pipe in a feeding direction of a dope for forming an intermittent layer of a polymer film;

FIG. 4 is a perspective view of a pipe and an addition nozzle, illustration a position thereof to a static mixer;

FIG. 5 is a partial-sectional view of the tube in a perpendicular direction to the feeding direction;

FIGS. 6A and 6B are charts illustrating results of researches of mixing conditions of the dope when a shape of the nozzle and several conditions are changed.

### PREFERRED EMBODIMENTS OF THE INVENTION

As for cellulose acylate, it is preferable that the degree of substitution of acyl groups for hydrogen atoms on hydroxyl groups of cellulose preferably satisfies all of following formulae (I)-(III).
2.5≦A+B≦3.0 (I)
0≦A≦3.0 (II)
0≦B≦2.9 (III)

In these formulae (I)-(III), A is the degree of substitution of the acetyl groups for the hydrogen atoms on the hydroxyl groups of cellulose, and B is the degree of substitution of the acyl groups for the hydrogen atoms while each acyl group has carbon atoms whose number is from 3 to 22. Note that at least 90 wt. % of TAC is particles having diameters from 0.1 mm to 4 mm.

A glucose unit constructing cellulose with β-1,4 bond has the free hydroxyl groups on 2^{nd}, 3^{rd} and 6^{th} positions. Cellulose acylate is polymer in which, by esterification, the hydrogen atoms on the part or all of the hydroxyl groups are substituted by the acyl groups having at least two carbon atoms. The degree of acylation is the degree of the esterification of the hydroxyl groups on the 2^{nd}, 3^{rd}, 6^{th} positions. In each hydroxyl group, if the esterification is made at 100%, the degree of acylation is 1. Therefore, if all of the three hydroxyl groups is esterified at 100%, the degree of acylation is 3.

Herein, if the acyl group is substituted for the hydrogen atom on the 2^{nd} position in a glucose unit, the degree of the acylation is described as DS2 (the degree of substitution by acylation on the 2^{nd} position), and if the acyl group is substituted for the hydrogen atom on the 3^{rd} position in the glucose unit, the degree of the acylation is described as DS3 (the degree of substitution by acylation on the 3^{rd} position). Further, if the acyl group is substituted for the hydrogen atom on the 6^{th} position in the glucose unit, the degree of the acylation is described as DS6 (the degree of substitution by acylation on the 6^{th} position). The total of the degree of acylation, DS2+DS3+DS6, is preferably 2.00 to 3.00, particularly 2.22 to 2.90, and especially 2.40 to 2.88. Further, DS6/(DS2+DS3+DS6) is preferably at least 0.28, particularly at least 0.30, and especially 0.31 to 0.34.

In the present invention, the number and sort of the acyl groups in cellulose acylate may be only one or at least two. If there are at least two sorts of acyl groups, one of them is preferable the acetyl group. If the hydrogen atoms on the 2^{nd}, 3^{rd} and 6^{th} hydroxyl groups are substituted by the acetyl groups, the total degree of substitution is described as DSA, and if the hydrogen atoms on the 2^{nd}, 3^{rd} and 6^{th} hydroxyl groups are substituted by the acyl groups other than acetyl groups, the total degree of substitution is described as DSB. In this case, the value of DSA+DSB is preferably 2.22 to 2.90, especially 2.40 to 2.88. Further, DSB is preferably at least 0.30, and especially at least 0.7. According to DSB, the percentage of the substitution on the 6^{th} position to that on the 2^{nd}, 3^{rd} and 6^{th} positions is at least 20%. However, the percentage is preferably at least 25%, particularly at least 30%, and especially at least 33%. Further, DSA+DSB of the 6^{th} position of the cellulose acylate is preferably at least 0.75, particularly at least 0.80, and especially at least 0.85. When these sorts of cellulose acylate are used, a solution (or dope) having preferable solubility can be produced, and especially, the solution having preferable solubility to the non-chlorine type organic solvent can be produced. Further, when the above cellulose acylate is used, the produced solution has low viscosity and good filterability.

Cellulose acylate is may be produced from cotton linter or cotton pulp, and preferably cellulose acylate is produced from cotton linter.

In cellulose acylate, the acyl group having at least 2 carbon atoms may be aliphatic group or aryl group. Such cellulose acylate is, for example, alkylcarbonyl ester and alkenylcarbonyl ester of cellulose. Further, there are aromatic carbonyl ester, aromatic alkyl carbonyl ester, or the like, and these compounds may have substituents. As preferable examples of the compounds, there are propionyl group, butanoyl group, pentanoly group, hexanoyl group, octanoyl group, decanoyl group, dodecanoyl group, tridecanoyl group, tetradecanyol group, hexadecanoyl group, octadecanoyl group, iso-butanoyl group, t-butanoyl group, cyclohexanecarbonyl group, oleoyl group, benzoyl group, naphthylcarbonyl group, cinamoyl group and the like. Among them, the particularly preferable groups are propionyl group, butanoyl group, dodecanoyl group, octadecanoyl group, t-butanoyl group, oleoyl group, benzoyl group, naphthylcarbonyl group, cinamoyl group and the like, and the especially preferable groups are propionyl group and butanoyl group.

Further, as solvents for preparing the dope, there are aromatic hydrocarbons (for example, benzene, toluene and the like), hydrocarbon halides (for example, dichloromethane, chlorobenzene and the like), alcohols (for example, methanol, ethanol, n-propanol, n-butanol, diethyleneglycol and the like), ketones (for example, acetone, methylethyl ketone and the like), esters (for example, methyl acetate, ethyl acetate, propyl acetate and the like), ethers (for example, tetrahydrofuran, methylcellosolve and the like) and the like.

The solvents are preferably hydrocarbon halides having 1 to 7 carbon atoms, and especially dichloromethane. Then in view of the solubility of cellulose acylate, the peelability of a casting film from a support, a mechanical strength of a film, optical properties of the film and the like, it is preferable that one or several sorts of alcohols having 1 to 5 carbon atoms is mixed with dichloromethane. Thereat the content of the alcohols to the entire solvent is preferably in the range of 2 mass % to 25 mass %, and particularly in the range of 5 mass % to 20 mass %. Concretely, there are methanol, ethanol, n-propanol, iso-propanol, n-butanol and the like. The preferable examples for the alcohols are methanol, ethanol, n-butanol, or a mixture thereof.

By the way, recently in order to reduce the effect to the environment to the minimum, the solvent composition when dichloromethane is not used is progressively considered. In order to achieve this object, ethers having 4 to 12 carbon atoms, ketones having 3 to 12 carbon atoms, esters having 3 to 12 esters are preferable, and a mixture thereof can be used. These ethers, ketones and esters may have the ring structure. Further, the compounds having at least two of functional groups (namely, —O—, —CO— and —COO—) in ethers, ketones and esters can be used for the solvent. Further, the solvent may have other functional groups, such as alcoholic hydroxyl groups, in the chemical structure.

The detail explanation of cellulose acylate is made from [0140] to [0195] in Japanese Patent Laid-Open Publication No. 2005-104148. The description of this publication is also applied to the present invention. Further, the additives (such as the solvent, plasticizer, deterioration inhibitor, UV absorbing agent, optically anisotropic controller, retardation controller, dyne, matting agent, release agent, releasing accelerator and the like) are described in detail from [0196] to [0516] of Japanese Patent Laid-Open Publication No. 2005-104148.

[Preparation of Polymer Solution]

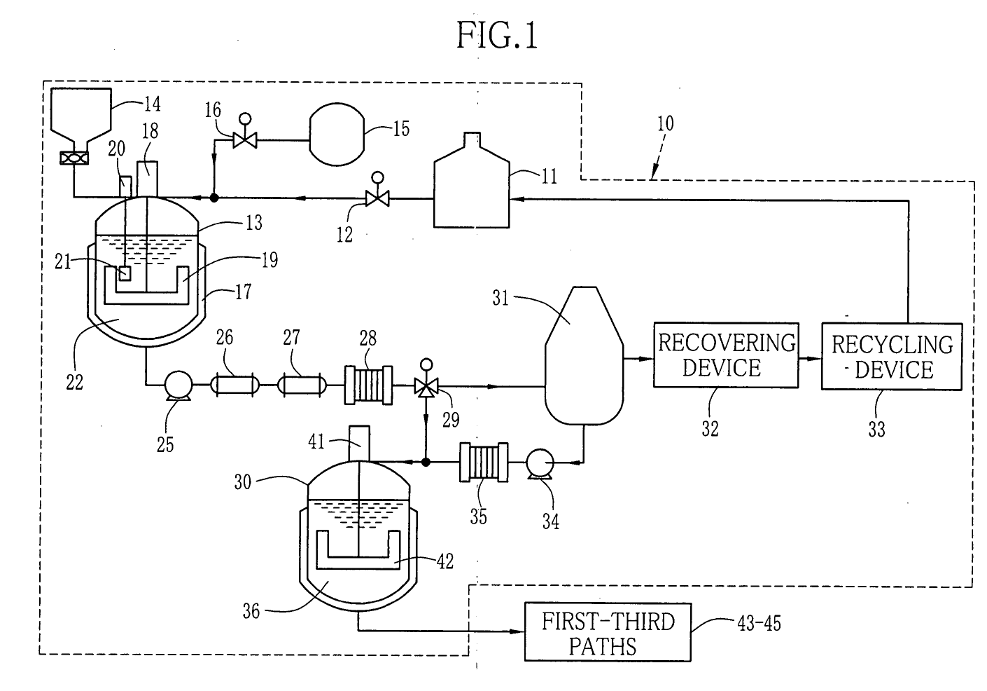

In FIG. 1, a dope production line 10 has a solvent tank 11 containing a solvent, a hopper 14 for feeding TAC, an additive tank 15 containing a solution of an additive (hereinafter additive solution), valves 12, 16 and a dissolution tank 13. When the valve 12 is opened, the solvent is sent to the dissolution tank 13. Then a necessary amount of TAC in the hopper 14 is sent with measuring to the dissolution tank 13. When the valve 16 is opened, a necessary amount of the additive solution is sent from the additive tank 15 to the dissolution tank 13. Note that if the additive is in the liquid state in the room temperature, it may be fed in the liquid state to the dissolution tank 13 without preparing for the additive solution. Otherwise, if the additive is in the solid state in the room temperature, it may be fed in the solid state to the dissolution tank 13 with use of a hopper. If plural sorts of additive compounds are used, the additive containing the plural additive compounds may be accumulated in the additive tank 15 altogether. Otherwise plural additive tanks may be used so as to contain the respective additive compounds, which are sent through independent pipes to the dissolution tank 13.

In the above explanation, the solvent, TAC, the additives are sequentially sent to the dissolution tank 13. However, the sending order is not restricted in it. For example, after the necessary amount of TAC is sent with measurement to the dissolution tank 13, the feeding of the preferable amount of the solvent may be performed. Further, it is not necessary that the additive are previously sent in the dissolution tank 13, and they may be added to a mixture of TAC and the solvent.

The dissolution tank 13 is provided with a jacket 17 covering over an outer surface of the dissolution tank 13, a first stirrer 19 to be rotated by a motor 18, and a second stirrer 21 to be rotated by a motor 20. The first stirrer 19 preferably has an anchor blade, and the second stirrer 21 is preferably an eccentric stirrer of a dissolver type. The inner temperature in the dissolution tank 13 is controlled with use of the heat transferring medium flowing in the jacket 17. The preferable inner temperature is in the range of −10° C. to 55° C. At least one of the first and second stirrers 19, 21 is adequately chosen for performing the rotation. Thus a swelling solution 22 in which TAC is swollen in the solvent is obtained. Note that the second stirrer 21 may be omitted. However, as in this embodiment, the second stirrer 21 is preferably provided.

In a downstream from the dissolution tank 13, the dope production line 10 further includes a pump 25, a heating device 26, a temperature controlling device 27, filtration devices 28, 35, a flushing device 31, and a stock tank 30.

The pump 25 is driven such that the swelling solution 22 in the dissolution tank 13 may be sent to the heating device 26 which is preferably a pipe with a jacket. Further, the heating device 26 preferably pressurizes the swelling solution 22. While only the heating or both of the heating and pressurizing of the swelling solution 22, the dissolution of TAC proceeds such that a polymer solution may be obtained. Note that the polymer solution may be a solution in which the polymer is entirely dissolved and a swelling solution in which the polymer is swollen. Further, the temperature of the swelling solution 22 is preferably in the range of 0° C. to 97° C. Instead of the heat-dissolution with use of the heating device 26, the swelling solution 22 may be cooled in the range of −150° C. to −10° C. so as to perform the dissolution, which is already known as the cool-dissolution method. In this embodiment, one of the heat-dissolution and cool-dissolution methods can be chosen in accordance with the properties of the materials, so as to control the solubility. Thus the dissolution of TAC to the solvent can be made enough. The polymer solution is fed to the temperature controlling device 27, so as to control the temperature nearly to the room temperature. Then the filtration of the polymer solution is made with the filtration device 28, such that impurities may be removed from the polymer solution. The filter used in the filtration device 28 preferably has an averaged nominal diameter of at most 100 μm. The flow rate of the filtration in the filtration device 28 is preferably at least 50 little/hr. The polymer solution after the filtration is fed through a valve 29 to the stock tank 30.

The polymer solution can be used as a dope for a film production, which will be explained. However, in the method in which the dissolution of TAC is performed after the preparation of the swelling solution, if it is designated that a polymer solution of high concentration is produced, the time for production of such dope becomes longer. Consequently, the production cost becomes higher. Therefore, it is preferable that a polymer solution of the lower concentration than the predetermined value is prepared at first and then the enrichment of the polymer solution is made. In this embodiment, the polymer solution after the filtration is sent to the flushing device 31 through the valve 29. In the flushing device 31, the solvent of the polymer solution is partially evaporated. The solvent vapor generated in the evaporation is condensed by a condenser (not shown) to a liquid state, and recovered by a recovering device 32. The recovered solvent is recycled by a recycling device 33 and reused. According to this method, the decrease of cost can be designated, since the production efficiency becomes higher and the solvent is reused.

The polymer solution after the enrichment as the above description is extracted from the flushing device 31 through a pump 34. Further, in order to remove bubbles generated in the polymer solution, it is preferable to perform the bubble removing treatment. As a method for removing the bubble, there are many methods which are already known, for example, an ultrasonic irradiation method and the like. Then the polymer solution is fed to the filtration device 35, in which the undissolved materials are removed. Note that the temperature of the polymer solution in the filtration device 35 is preferably in the range of 0° C. to 200° C. Thus a dope is produced the produced dope has the TAC concentration in the range of 5 wt. % to 40 wt. %. Thus a polymer solution 36 is obtained and accumulated in the stock tank 30.

The stock tank 30 is provided with a motor 41 and a stirrer 42. The motor 41 is driven to rotate the stirrer, and thus the polymer solution 36 is always uniform.

Note that the method of producing the polymer solution is disclosed in detail in [0517] to [0616] in Japanese Patent Laid-Open Publication No. 2005-104148, for example, the dissolution method and the adding methods of the materials, the raw materials and the additives in the solution casting method for forming the TAC film, the filtering method, the bubble removing method, and the like. Note that the polymer film to be produced has a three layer structure. A lowermost layer of the polymer film on the belt 76 is formed from the second dope, an uppermost layer of the polymer film on the belt 76 is formed from the third dope, and an intermittent layer is formed from the first dope.

[Solution Casting Method]

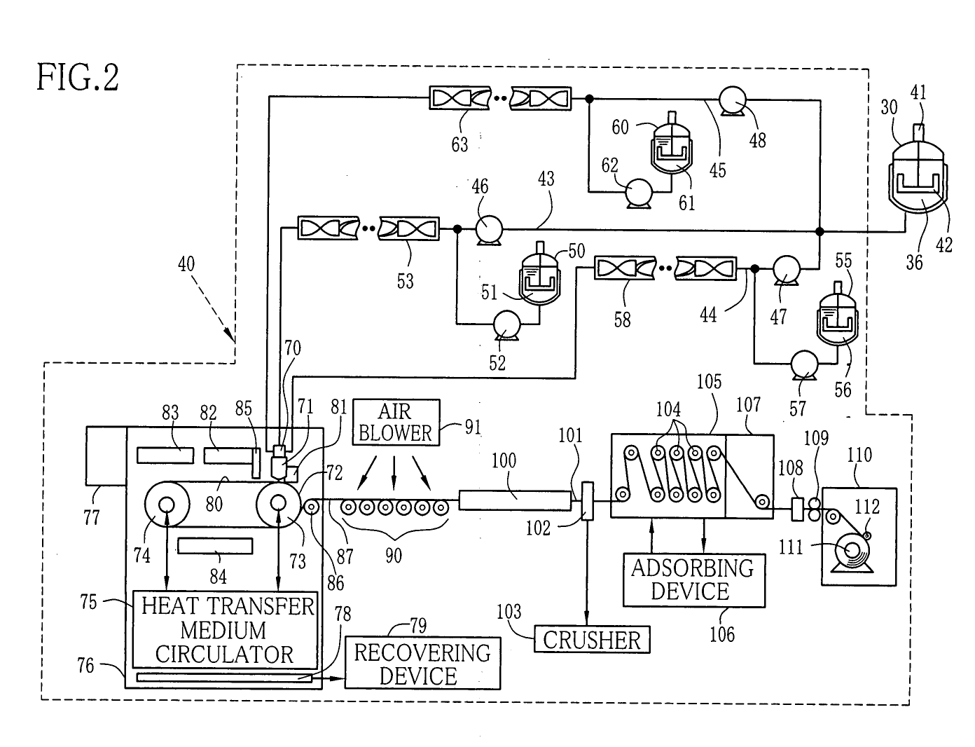

A solution casting method for forming a polymer film will be explained in followings. As shown in FIG. 2, the stock tank 30 is connected to a first path 43, a second path 44 and a third path 45. Through the first-third paths 43-45, the polymer solution 36 is fed by pumps 46-48 respectively disposed on the first-third paths 43-45, and first to third dopes are prepared and fed to a feed block 70. After the feed block 70, these dopes are cast onto a belt 72.

(Dope Production Process)

A stock tank 50 contains an additive 51, which are added to the polymer solution 36 fed in the first path 43 by a pump 52. Thereafter the mixture is stirred by a static mixer 53, so as to be uniform. Thus the first dope used for forming the intermittent layer is obtained. The additive 51 is a solution (or a dispersion) previously containing additive compounds, for example, UV absorbing agent, retardation controller and the like.

A stock tank 55 contains an additive 56, which are added to the polymer solution 36 fed in the second path 44 by a pump 57. Thereafter the mixture is stirred by a static mixer 58, so as to be uniform. Thus the second dope used for forming a lowermost layer of the polymer film on the belt 76 is obtained. The additive 56 previously contains additive compounds, for example, peeling agent (for example citric acid ester and the like) which makes the peeling of the polymer film from a belt as the support easy, matting agent (silicone dioxide and the like) for reducing the adhesion of film surfaces in the film roll, and the like. Note that the additive 56 may contain the additive compounds, such as plasticizer, UV absorbing agent and the like.

A stock tank 60 contains an additive 61, which are added to the polymer solution 36 fed in the third path 45 by a pump 62. Thereafter the mixture is stirred by a static mixer 63, so as to be uniform. Thus the third dope used for forming an uppermost layer of the polymer film on the belt 76 is obtained. The additive 61 contains the additive compounds, such as matting agent (silicone dioxide and the like) for reducing the adhesion of film surfaces in the film roll, and the like. Note that the additive 56 may contain the additive compounds, such as peeling accelerator, plasticizer, UV absorbing agent and the like.

Note in the present invention that improvements are made in points, such as a shape of a nozzle 160 for adding the additives to the polymer solutions 36 in each of the first-third paths 43-45, a distance between the addition nozzle 160 and each of the static mixers 53, 58, 63, and a flow rate velocity of the additive to the polymer solution. Thus the additives and the polymer solutions are stirred efficiently.

The first-third dopes obtained by adding the additives to the polymer solution 36 are fed to the feed block 70 at a predetermined flow volume. The first-third dopes are joined and then cast from a casting die 71 to a belt 72.

(Casting Process)

The materials of the casting die 71 are preferably double phase stainless. The preferable material has coefficient of thermal expansion of at most 2×10⁻⁵(° C.⁻¹). Further, the material to be used has an anti-corrosion property, which is almost the same as SUS316, in the examination of forcible corrosion in the electrolyte solution. Preferably, the materials to be used for the casting die 71 has such resistance of corrosion that the pitting doesn't occur on the gas-liquid interface even if the material is dipped in a mixture of dichloromethane, methanol and water for three months. The casting die 71 is preferably manufactured by performing the polishing after a month from the material casting. Thus the surface condition of the dope flowing in the casting die 71 is kept uniform. The finish precision of a contact face of the casting die to the feed block (explained later) 70 is at most 1 μm in surface roughness and at most 1 μm/m in straightness. The clearance of a slit of the casting die 71 is automatically adjustable in the range of 0.5 mm to 3.5 mm. According to an edge of the contact portion of a lip end of the casting die 71 to the dope, R (R is chamfered radius) is at most 50 μm in all of a width. Further, the shearing rate in the casting die is controlled in the range of 1 to 5000 per second.

A width of the casting die 71 is not restricted especially. However, the width is preferably at least the same and at most 2.0 times as large as a film width. Further, it is preferable to attach a temperature controlling device (not shown) to the casting die 71, such that the temperature may be kept to the predetermined one during the film production. Furthermore, the casting die 71 is preferably a coat hanger type die.

In order to adjust a film thickness, the casting die 71 is preferably provided with an automatic thickness adjusting device. For example, thickness adjusting bolts (heat bolts) are disposed at a predetermined interval in a widthwise direction of the casting die 71. According to the heat bolts, it is preferable that the profile is set on the basis of a predetermined program, depending on feed rate of pumps (preferably, high accuracy gear pumps) 46-48, while the film production is performed. Further, the feed back control of the adjustment value of the heat bolts may be made by the adjusting program on the base of the profile of a thickness meter (not shown), such as infrared ray thickness meter and the like. The thickness difference between any two points in the widthwise direction except the side edge portions in the casting film is controlled preferably to at most 3 μm, and especially at most 1 μm. Further, the accuracy to the designated object value of the thickness is preferably in ±1.5 μm.

Preferably, a hardened layer is preferably formed on a top of the lip end. A method of forming the hardened layer is not restricted. But it is, for example, ceramics hard coating, hard chrome plating, neutralization processing, and the like. If ceramics is used as the hardened layer, it is preferable that the used ceramics is grindable but not friable, with a lower porosity, high resistance of corrosion, and no adhesiveness to the casting die 70. Concretely, there are tungsten carbide (WC), Al₂O₃, TiN, Cr₂O₃, and the like. Especially preferable ceramics is tungsten carbide. Tungsten carbide coating can be made by an spraying method.

Further, in order to prevent the partial dry-solidifying of a dope flowing on a slit end of the casting die 71, it is preferable to provide a solvent supplying device (not shown) at the slit end, on which a gas-liquid interfaces are formed between both edges of the slit and between both bead edges and the outer gas. Preferably, these gas-liquid interfaces are supplied with the solvent which can dissolve the dope, (for example a mixture solvent of dichloromethane 86.5 pts.mass, acetone 13 pts.mass, n-butanol 0.5 pts.mass). Thus the solidifications at both bead edges and the mixing of the solid into the casting film are prevented. Note that the pump for supplying the solvent has a pulse rate at most 5%.

The belt 72 is positioned below the casting die 71, and lapped on back-up rollers 73, 74. When the back-up rollers 73, 74 are rotated by the driving device (not shown), and thus the belt 72 runs endlessly in accordance with the rotation of the back-up rollers 73, 74. Then the casting speed is preferably in the range of 10 m/min to 200 m/min. Further, the temperatures of the back-up rollers 73, 74 are controlled by a heat transfer medium circulator 75 for cycling a heat transfer medium. It is preferable that the surface temperature of the belt 72 is adjusted in the range of −20° C. to 40° C. by heat transmission from the back-up rollers 73, 74. In this embodiment, paths (not shown) of the heat transfer mediums are formed in the back-up rollers 73, 74, and the heat transfer mediums whose temperatures are controlled by the heat transfer medium circulator 75 pass through the paths. Thus the temperature of the back-up rollers 73, 74 are kept to the predetermined values.

The width and the length of the support 72 are not restricted especially. However, it is preferably 1.1 to 3.0 times as large as the casting width. Preferably, the length is from 10 m to 200 m, and the thickness is from 0.3 mm to 10 mm. The surface is preferably polished so as to have a surface roughness at most 0.05 μm. The belt 72 is preferably made of stainless steel, and especially of SUS 316 so as to have enough resistance of corrosion and strength. The thickness unevenness of the entire belt 72 is preferably at most 0.5%.

The drive of the back-up rollers 73, 74 is preferably controlled such that the tension generated in the belt 72 may be 1.5×10⁴ kg/m and (the difference of) the relative speed between the belt 72 and each back-up roller 73, 74 is at most 0.01 m/min. According to the control of the belt 72, preferably, the change of the running speed is at most 0.5% from the predetermined value, and the meandering in the widthwise direction in one cycle running is at most 1.5 mm. In order to reduce the meandering, a detector (not shown) is preferably provided above each edge portion of the belt 72, so as to make a feed-back control of the position of the belt on the basis of measured values. Furthermore, the position of the belt 72 shifts up- and downwardly in accordance with the rotation of the back-up roller 73. Therefore, it is preferable that the position of the belt 72 is preferably controlled just below the casting die 71, such that a shift range of the belt 72 may be at most 200 μm.

Note that it is possible to use one of the back-up rollers 73, 74 as support. In this case, the roller is preferably rotated at high accuracy. Therefore the surface roughness is preferably at most 0.01 μm. Further, the chrome plating is preferably performed to the drum such that the drum may have enough hardness and endurance. As described above, it is preferable in the support that the surface defect must be reduced to be minimal. Concretely there are no pin hole of at least 30 μm, at most one pin hole in the range of 10 μm to 30 μm, and at most two pin holes of less than 10 μm per 1 m².

The casting die 71, the belt 72 and the like are included in a casting chamber 76, and a temperature controlling device 77 is provided for controlling the inner temperature of the casting chamber 76 to the predetermined value. Preferably, the inner temperature is in the range of −10° C. to 57° C. The organic solvent evaporated in the casting chamber 76 is condensed by a condenser 78. The condensed organic solvent is recovered by a recovering device 79 and used as the solvent for preparing the dope.

In the present invention, the first-third dopes produced as described above are co-cast to form a casting film 80 on the belt 72. Preferably, the temperatures of the first-third dopes are in the range of −10° C. to 57° C. Further, in order to stabilize the formation of a bead of the cast dopes, there is a decompression chamber 81 for controlling the pressure in the back side of the bead. The decompression is preferably made such that the pressure difference of a back to a front side from the bead may be in the range of −100 Pa to −2000 Pa.

It is preferable to provide the decompression chamber 81 with a jacket (not shown) for controlling the inner temperature. The temperature of the decompression chamber 81 is not restricted especially. However, the temperature is preferably in the range of 10° C. to 50° C. Further, aspirators (not shown) may be provided with the decompression chamber 81 so as to be near both side edges of a dope outlet of the casting die 71. Thus the aspiration in both side edges of the bead is made to stabilize the shape of the bead. In this case, the force velocity of the aspiration is preferably in the range of one to one hundred Litter/min.

The casting film 80 is transported in accordance with the running of the belt 72. In this embodiment, it is preferable to provide air blowers 82, 83, 84 for feeding air blows to evaporate the solvent in the casting film 80. In this embodiment, the position for attachment of each air blower 82, 83, 84 is in an upper and upstream side, an upper and downstream side, and a lower side of the belt 72. However, the present invention is not restricted in it. Further, an air shielding device 85 is disposed close to the casting film 80 in the downstream side from the casting die 71. Although the drying airs cause to change surface conditions of the casting film 80 just after the formation, an air shielding device 85 reduces the change of the surface conditions. Further, in this figure, the belt is used as the support. However, a drum like the back-up roller may be used as the support, and the surface temperature of the drum is preferably in the range of 20° C. to 40° C.

(Peeling Process & Drying Process)

When the casting film 80 has self-supporting property, it is peeled as a wet film 87 from the belt 72 with support of a peel roller 86. Thereafter, the wet film 87 is transported through an interval section 90 in which many rollers are provided, and then enters into a tenter device 100.

In the interval section 90, there is an air blower 91 for feeding a drying air whose temperature is a predetermined value. Thus the drying of the wet film 87 proceeds. At this moment, the temperature of the drying air from the air blower 91 is preferably in the range of 20° C. to 250° C. In the interval section 90, the rotation speed of the one roller is higher than the neighboring roller in the upstream side. Thus the tension can be applied to the wet film 87 in the transporting direction.

In the tenter device 100, both side edge portions of the wet film 87 are held by holding members, such as clips and the like, and the wet film 87 is dried with the transportation. The tenter device 100 of this embodiment stretches the wet film 87 in the widthwise direction. Thus, in the interval section 90 and/or the tenter device 100, it is preferable that the wet film 87 is stretched to become larger by 0.5% to 300% in at least one of the transporting direction (or a casting direction) and the widthwise direction.

According to the polymer film of the present invention, an axial misalignment between the slow axis in an arbitrary region of the polymer film and the slow axis in all regions next to the arbitrary region is preferably less than 2.0°. Note that the axial difference is particularly preferably less than 1.0°. Further, the polymer film produced by the solution casting method is preferably used in the present invention. In the solution casting method, after the stretching in the widthwise direction of the polymer film, the relaxation in the widthwise direction is preferably made.

The stretching and the relaxation are performed while the both side edge portions are held by holders (such as clips and the like). When both side edge portions are held before the stretching, the film width is described as L1 (mm), and when the film is stretched maximally, the film width is described as L2 (mm). Further, when both side edge portions are released from the holders after the relaxation, film width is described as L3 (mm). The film stretching is preferably made with satisfying a condition:
1<{(L2-L3)/L1}×100<15
During the stretch-relaxation, the drying temperature of the film is preferably kept at the almost same value in the range of 50° C. to 180° C. In the present invention, the polymer film contains a film produced by a melt extrusion method.

Preferably, the region above described is square, and determined such that every edge of the square may be 50 mm. The polymer film is preferably a cellulose ester film. The cellulose ester film is preferably a cellulose acylate film, particularly a cellulose acetate film, and especially a cellulose triacetate film. Further, in the present invention, the polymer film may be uses as several sorts of optically functional films, for example, a base film of a photosensitive material, a protective film of a polarizing filer, a base film of optical compensation film, and the like. Further, in the present invention, the polymer film may be used as optically functional film in a liquid crystal display.

In the solution casting method of the present invention, the dope containing the polymer and the solvent is cast onto the support to form the film, and the peeling of the film from the support is made. Further, while the stretching and the relaxation are made with holding both side edge portions, it is preferable to perform the relaxation after the stretching. When the stretching and the relaxation are performed, both side portions are held. When both side edge portions are held before the strtching, film width is described as L1 (mm), and when the film is stretched maximally, film width is described as L2 (mm). Further, when both side edge portions are releases from the holders after the relaxation, film width is described as L3 (mm). The film stretching is preferably made with satisfying a condition of 1<{(L2-L3)/L1}×100<15

When the stretching and the relaxation are made, it is preferable to keep the drying temperature of the film to the predetermined value in the range of 50° C. to 180° C.

The wet film 87 is dried until the content of the remaining solvent become the predetermined value, and fed out from the tenter device 100 as film 101 toward an edge slitting device 102 for slitting off both side edge portions. The slit side edge portions are sent to a crusher 103 by a cutter blower (not shown), and crushed to tips by the crusher 103. The tips are reused for preparing the dope, which is effective in view of the decrease of the production cost. Note that the slitting process of both side edge portions may be omitted. However, it is preferable to perform the slitting between the casting process and the winding process.

The film 101 whose side edge portions are slit off is sent to a drying device 105 and dried furthermore. In the drying device 105, the film 101 is transported with lapping on rollers 104. The inner temperature of the drying device 105 is not restricted especially. However, it is preferable in the range of 50° C. to 180° C. The solvent vapor evaporated from the film 101 by the drying device 105 is adsorbed by an adsorbing device 106. The air from which the solvent components are removed is reused for the drying air in the drying device 105. Note that the drying device 105 preferably has plural partitions for variation of the drying temperature. Further, a pre-drying device (not shown) is provided between the edge slitting device 102 and the drying device 105, so as to perform the pre-drying of the film 101. Thus it is prevented that the temperature of the film 101 increases rapidly, and therefore the change of the shape of the film 101 is reduced.

The film 101 is transported toward a cooling chamber 107, and cooled therein to around the room temperature. A humidity control chamber (not shown) may be provided for conditioning the humidity between the drying device 105 and the cooling chamber 107. Preferably, in the humidity control chamber, an air whose temperature and humidity are controlled is applied to the film 101. Thus the curling of the film 101 and the winding defect in the winding process can be reduced.

Thereafter, a compulsory neutralization device (or a neutralization bar) 108 eliminates the charged electrostatic potential of the film 101 to the predetermined value (for example, in the range of −3 kV to +3 kV). The position of the neutralization process is not restricted in this embodiment. For example, the position may be a predetermined position in the drying section or in the downstream side from a knurling roller 109, and otherwise, the neutralization may be made at plural positions. After the neutralization, the embossing of both side portions of the film 101 is made by the embossing rollers to provide the knurling. The emboss height from the bottom to the top of the embossment is in the range of 1 μm to 200 μm.

(Winding Process)

In the last process, the film 101 is wound by a winding shaft 111 in the winding chamber 110. At this moment, a tension is applied at the predetermined value to a press roller 112. Preferably, the tension is gradually changed from the start to the end of the winding. In the present invention, the length of the film 101 is preferably at least 100 m. The width of the film is preferably at least 600 mm, and particularly in the range of 1400 mm to 1800 mm. Further, even if the width is more than 1800 mm, the present invention is effective.

In the solution casting method of the present invention, there are casting methods for casting plural dopes, for example, a co-casting method and a sequential casting method. In the co-casting method, a feed block 70 maybe attached to the casting die 71 as in this embodiment, or a multi-manifold type casting die (not shown) may be used. In the film of multi-layer structure, at least one of the thickness of the peeled layer (1^{st} layer) from the support and that of the opposite layer (2^{nd} layer) thereto is preferably in the range of 0.5% to 30% of the total film thickness. Furthermore, when it is designated to perform the co-casting, a dope of higher viscosity is sandwiched by lower-viscosity dopes. Concretely, it is preferable that the dopes for forming the surface layers have lower viscosity than the dope for forming a layer sandwiched by the surface layers. Further, when the co-casting is designated, it is preferable in the bead between die slit and the support that the composition of alcohol is higher in the two outer dopes than the inner dope.

As shown in FIG. 2, the three sorts of dopes are cast so as to easily form the film 101 as production object. Namely, the film 101 is wound to the film roll, it is necessary to prevent the adhesion of the film in the film roll. Therefore, it is preferable that the dope contains the matting agents. However, the matting usually agents cause the degradation in the optical properties. In this embodiment, accordingly, the matting agents are contained in the outer dopes for forming the lowermost and uppermost surface of the casing film on the support. Namely, the inner dope doesn't contain any matting agents. Thus the surface adhesiveness is decreased, and the film can have the designated optical properties.

Japanese Patent Laid-Open Publication No. 2005-104148 describes from [0617] to [0889] in detail about the structures of the casting die, the decompression chamber, the support and the like, and further about the co-casting, the peeling, the stretching, the drying conditions in each process, the handling method, the curling, the winding method after the correction of planarity, the solvent recovering method, the film recovering method. The descriptions thereof can be applied to the present invention.

[Properties & Measuring Method]

(Degree of Curl & Thickness)

Japanese Patent Laid-Open Publication No. 2005-104148 describes from [0112] to [0139] about the properties of the wound cellulose acylate film and the measuring method thereof. The properties and the measuring methods can be applied to the present invention.

[Surface Treatment]

The cellulose acylate film is preferably used in several ways after the surface treatment of at least one surface. The preferable surface treatments are vacuum glow discharge, plasma discharge under the atmospheric pressure, UV-light irradiation, corona discharge, flame treatment, acid treatment and alkali treatment. Further it is preferable to make one of these sorts of the surface treatments.

[Functional Layer]

(Antistatic, Curing, Antireflection, Easily Adhesive & Antiglare Layers)

The cellulose acylate film may be provided with an undercoating layer on at least one of the surfaces, and used in the several ways.

It is preferable to use the cellulose acylate film as a base film to which at least one of functional layers may be provided. The preferable functional layers are an antistatic layer, a cured resin layer, an antireflection layer, an easily adhesive layer, an antiglare layer and an optical compensation layer.

Conditions and Methods for forming the functional layer are described in detail from [0890] to [1087] of Japanese Patent Laid-Open Publication No. 2005-104148, which can be applied to the present invention. Thus, the produced film can have several functions and properties.

These functional layers preferably contain at least one sort of surfactants in the range of 0.1 mg/m² to 1000 mg/m². Further, the functional layers preferably contain at least one sort of plasticizers in the range of 0.1 mg/m² to 1000 mg/m². The functional layers preferably contain at least one sort of matting agents in the range of 0.1 mg/m² to 1000 mg/m². The functional layers preferably contain at least one sort of antistatic agents in the range of 1 mg/m² to 1000 mg/m².

(Variety of Use)

The produced cellulose acylate film can be effectively used as a protection film for a polarizing filter. In the polarizing filter, the cellulose acylate film is adhered to a polarizer. Usually, two polarizing filters are adhered to a liquid crystal layer such that the liquid crystal display may be produced. Note that the arrangement of the liquid crystal layer and the polarizing filters are not restricted in it, and several arrangements already known are possible. Japanese Patent Laid-Open Publication No. 2005-104148 discloses the liquid crystal displays of TN type, STN type, VA type, OCB type, reflective type, and other types in detail. The description may be applied to the present invention.

Further, in the description of this application, a cellulose acylate film is provided with an optically anisotropic layer, and another cellulose acylate film is provided with antireflective and antiglare functions. Further, the publication describes about the optically biaxial cellulose acylate film provided with adequate optical properties. This cellulose acylate film may be used with the protective film for the polarizing filter. These descriptions of the Laid-Open Publication No. 2005-104148 continues from [1088] to [1265], which can be applied to the present invention.

In the method of forming the polymer film of the present invention, the formed cellulose acylate film is excellent in optical properties. The TAC film can be used as the protective film for the polarizing filter, a base film of the photosensitive material, and the like. Further, in order to improve the view angular dependence of the liquid crystal display (used for the television and the like), the produced film can be also used for the optical compensation film. Especially, the produced film is effectively used when it doubles as protective film for the polarizing filter. Therefore, the film is not only used in the TN-mode as prior mode, but also IPS-mode, OCB-mode, VA-mode and the like. Further, the polarizing filter may be constructed so as to have the protective film as construction element.

In followings, the dope production process will be explained in detail. In this embodiment, the difference among the first-third paths 43-45 is exactly the sorts of additives, and each path 43-45 substantially has the same construction. Therefore, in the following explanation, the first path 43 is described as representation of the three paths 43-45.

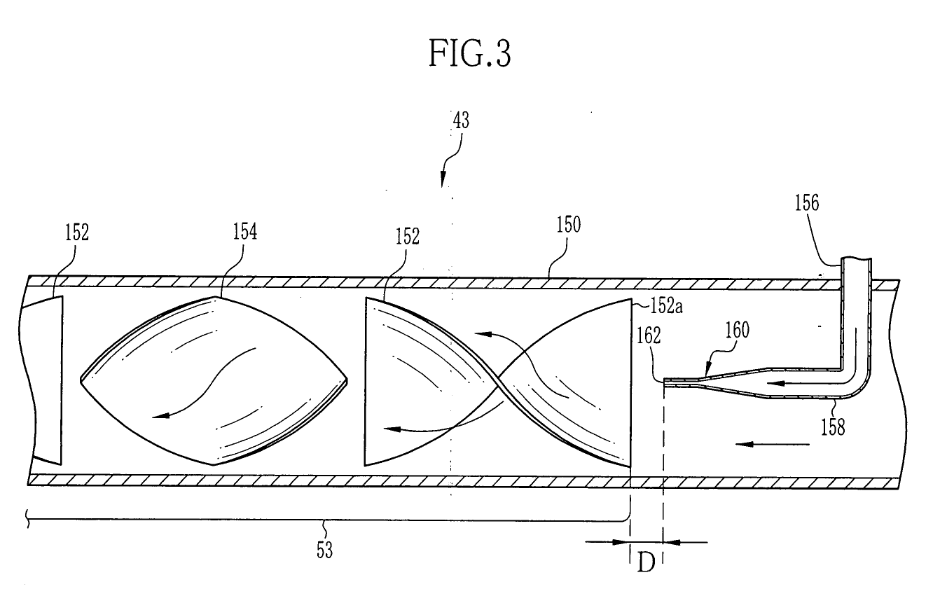

In FIG. 3, the first path 43 has a pipe 150 for feeding the polymer solution which is used for preparation of the dope for forming the intermittent layer. The pipe 150 incorporates a plurality of the static mixer 53. In the static mixer 53, first elements 152 and second elements 154 are arranged alternately in a lengthwise direction of the pipe 150. Each of the first and second elements 152, 154 is formed by wrenching a rectangle plate at 180°. However, the wrenching direction is opposite between the elements 152 and 154. The first elements and second elements are inclined 90 degrees with respect to the axis of the pipe and disposed in such a way that side edge portions of the first elements and second elements become orthogonal. The polymer solution and the additive fed to the pipe are reversed and mixed by the first elements and the second elements of the static mixer while passing through the pipe.

In this figure, the upstream side from the static mixer 53, there is an exit of an addition tube 156 which is provided through a wall of the pipe 150. An end of the addition tube 156 is provided with the addition nozzle 160. Thus the additive 51 to the dope for forming the intermittent layer is fed from the stock tank 50 by the pump 52, and supplied into the pipe 150 through the addition nozzle 160.

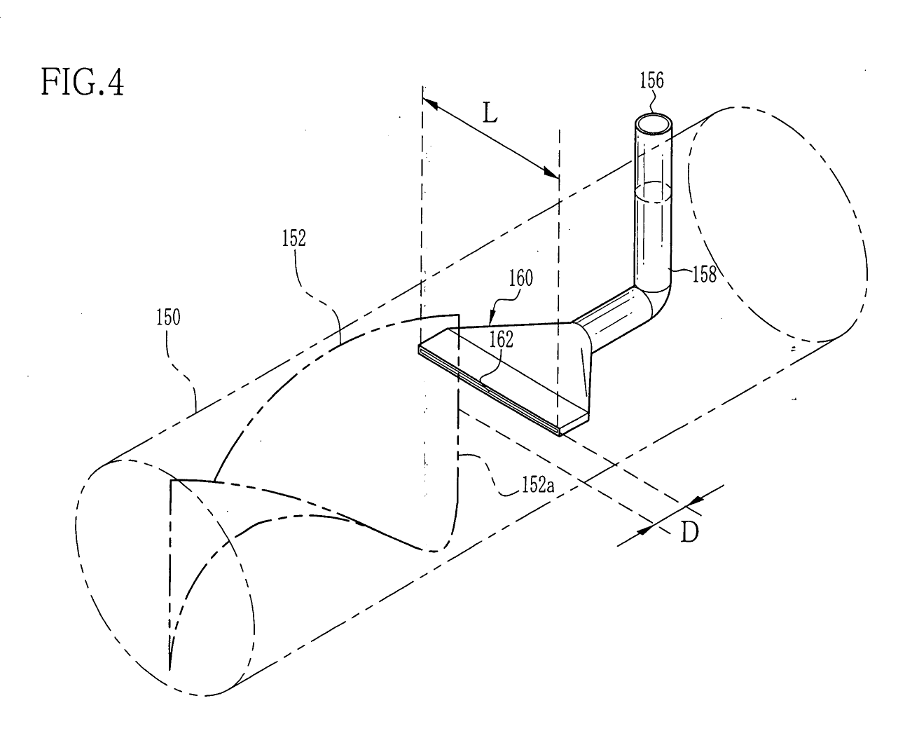

As shown in FIGS. 4 & 5, the addition nozzle 160 is formed such that an end portion thereof may extend in the diameter direction of the pipe 150. In the end of the addition nozzle 160, a slit 162 having slit-like shape is formed, and the additive 51 is added through a slit of the slit 162. The slit 162 of the addition nozzle 160 is disposed so as to be almost perpendicular to an upstream end 152a of the element 152 which is nearest to the addition nozzle 160. When the additive is added through the slit 162, the additive is separated into plural flux, and the additive is supplied to the polymer solution in the pipe 150. Thus the stirring of the polymer solution and the additives is effectively made, and the dope for forming the intermittent layer can be obtained.

In order to mix the additive and the polymer solution more efficiently, a percentage of a slit length L of the slit 162 to an inner diameter of the pipe 150 is preferably in the range of 20% to 98%. If the slit length L is too short, the stirring is not efficiently made. Further, if the slit length L is too large, some of the additive is fed into a space between the element 152 and an inner wall of the pipe 150.

A slit clearance C of the slit 162 is preferably at least 0.1 mm and at most 1/10 of an inner diameter W of the pipe 150. Further, a distance D between the slit 162 to the upstream end 152a of the element 152 is preferably in the range of 1 mm to 250 mm, and particularly in the range of 2 mm to 250 mm. If the distance D is too small, the resistance of the polymer solution to the additive becomes larger, and therefore the nozzle 160 is sometimes stopped. If the distance D is too large, the additive can't be supplied to a center of the static mixer 53.

Further, if flow velocity of the additive is V1 and that of the polymer solution is V2, a condition is preferably satisfied: 1≦V1/V2≦5. If the value V1/V2 is too small, the additive is sometimes not supplied. If the value V1/V2 is too large, the additive has large energy, and therefore passes through the static mixer 53 energetically.

Viscosity N1 of the additive is preferably in the range of 0.1 cp to 100 cp at 20° C., and viscosity N2 of the polymer solution is in the range of 5000 cp to 500000 cp at 20° C. Further the ratio of viscosity preferably satisfies a condition: 1000≦N2/N1≦1000000.

Further, shearing rate V3 of the polymer solution flowing in the pipe 150 is preferably in the range of 0.1 (1/s) to 30 (1/s). If the shearing rate V3 is too small, the mixing doesn't made enough. If the shearing rate V3 is too large, the pressure loss in the pipe 150 is larger, and therefore the 20 kg of withstand pressure is not enough. For the same reason, Reynolds number Re of the polymer solution preferably satisfies a condition of Re≦200.

The adding ratio of the additive is preferably in the range of 0.1% to 50% in flow volume rate. If the adding ratio is too small, it is hard to perform the accurate adding. If the adding ratio is too large, the mixing of the addition to the polymer solution becomes harder.

According to the present invention, since the additive is added through a slit-like slit extending in a diameter direction of the pipe in which the polymer solution flows, the stirring of the additive and the polymer solution is efficiently made. Therefore, a number of the elements can be made smaller, such that the process may be smaller and the production cost may be reduced. Further, since the uniform dope can be obtained by efficiently mixing of the additive and the polymer solution, the uniform dope can be obtained. Consequently, the present invention can be applied to the solution casting method in which the dope is used, such that high quality products of the protective film for the polarizing filter, the polarizing filter, the film base and the like.

In the present invention, the static mixer including wrenched elements is used as inline mixer. However, the present invention is not restricted in it, and another type of inline mixer may be used. As inline mixer usable in the present invention, for example, there is a sulzer mixer including elements formed by combining plural long strip of plates in grid structure.

[Experiment]

According to the present invention, an experiment was made. In followings, examples and comparisons of the experiment will be described.

(Composition)

| | | |
|---|---|---|
| Cellulose Triacetate | 100 | pts. mass |
| (Powder: degree of substitution, 2.84; viscosity- | | |
| average degree of polymerization, 306; water | | |
| content, 0.2 mass %; viscosity of 6 mass % | | |
| dichloromethane solution, 315 mPa · s; | | |
| averaged particle diameter, 1.5 mm; standard | | |
| deviation of particle, 0.5 mm) | | |
| Dichloromethane (first solvent compound) | 320 | pts. mass |
| Methanol (second solvent compound) | 83 | pts. mass |
| 1-butanol (third solvent compound) | 3 | pts. mass |
| Plasticizer A (triphenylphosphate) | 7.6 | pts. mass |
| Plasticizer B (diphenylphosphate) | 3.8 | pts. mass |

(Cotton Compounds)

According to cellulose triacetate used in this experiment, the remaining content of acetic acid was at most 0.1 mass %, the Ca content was 58 ppm, the Mg content was 42 ppm, the Fe content was 0.5 ppm, the free acetic acid was 40 ppm, and the sulfuric ion content was 15 ppm. The degree of acetylation at 6^{th} position was 0.91, and the percentage of acetyl groups at 6^{th} position to the total acetyl groups was 32.5%. The acetone extract was 8 mass %, and a ratio of weight-average molecular weight to number-average molecular weight was 2.5. Further, yellow index was 1.7, haze was 0.08, and transparency was 93.5%. Tg (measured by DSC) was 160° C., and calorific value in crystallization was 6.4 J/g. This cellulose triacetate is synthesized from cellulose as material obtained from cotton.

(1) Preparation for Polymer Solution

The polymer solution was prepared with use of the dope production line 10 in FIG. 1. The dissolution tank 13 with the first and second stirrers 21 was made of stainless and the volume thereof was 4000 L. Into the dissolution tank 13, plural solvent compounds were mixed such that a mixture solvent was obtained. While the stirring of the mixture solvent was made, the cellulose triacetate flakes were added from the hopper 14 to the mixture solvent gradually, such that the total mass of the mixture solution and the cellulose triacetate flakes might be 2000 kg. Note that the water content in each solvent compound is at most 0.5 mass %. The stirring was made with use of the first stirrer 19 having the anchor blade and the second stirrer 21 which was eccentric stirrer of dissolver type. At first, the first stirrer 19 performed the stirring at one m/sec as circumferential velocity (shear stress was 1×10⁴ kgf/m/sec²), and the second stirrer 21 performed the stirring at shear rate at first 5 m/sec (shear stress was 5×10⁴ kgf/m/sec²). Thus the dispersion was made for 30 minutes during the stirring. The dissolving started at 25° C., and the temperature of the dispersion became 48° C. at last. After the dispersion, the high speed stirring (of the second stirrer 21) was stopped, and the stirring was performed by the first stirrer 19 at 0.5 m/sec as circumferential velocity for 100 minutes. Thus cellulose triacetate flakes was swollen such that the swelling solution 22 was obtained. Until the end of the swelling, the inner pressure of the dissolution tank 13 was increased to 0.12 MPa with use of nitrogen gas. At this moment, the hydrogen concentration in the dissolution tank was less than.2 vol. %, which does not cause the explosion. Further, water content in the polymer solution was 0.3 mass %.

(2) Dissolution & Filtration

The pump 25 is driven to feed the swelling solution 22 from the dissolution tank 13 to the heating device 26 which is the tube with the jacket. In the heating device 26, the swelling solution 22 was heated to 50° C., and thereafter heated under the application of pressure at 2 MPa to 90° C. Thus the dissolving was made completely. The heating time was 15 minutes. The temperature of the swelling solution 22 is decreased to 36° C. by the temperature controlling device 27, and then filtrated through the filtration device 28 having filtration material whose nominal diameter was 8 μm. Thus the content of solid compounds was 19 mass %. At this moment, the primary filtration pressure was 1.5 MPa, and the secondary filtration pressure was 1.2 MPa. Since the filter, the housing and the pipes were made of hastelloy alloy and used at high temperature, they were made from materials excellent in corrosion resistance. Further, the jacket had endurance even if the heating medium for keeping or increasing the temperature was fed into the jacket.

(3) Condensation, Filtration & Defoaming

The polymer solution was fed into the flushing device 31 whose pressure was kept to the atmospheric pressure at 80° C., such that the flush evaporation of the polymer solution was made. The solvent vapor was condensed by the condenser to the liquid state, and recovered by the recovering device 32. After the flushing, the content of solid compounds in the polymer solution was 21.8 mass %. Note that the recovered solvent was recycled by the recycling device 33 and reused. The anchor blade is provided at a center shaft of a flush tank of the flushing device 31, and the polymer solution was stirred by the anchor blade at 0.5 m/sec as circumferential velocity. The temperature of the polymer solution in the flush tank was 25° C., the retaining period of the polymer solution in the flush tank was 50 minutes. Part of the polymer solution was sampled, and the measurement of the shearing viscosity was made at 25° C. The shearing viscosity was 450 Pa·s at 10 (1/s) of shearing rate.

Then the defoaming was further made by irradiating very weak ultrasonic waves. Thereafter, the polymer solution was fed to the filtration device 35 by the pump 34 under the application of pressure at 1.5 MPa. In the filtration device 35, the polymer solution was fed at first through a sintered fiber metal filter whose nominal diameter was 10 μm, and then through the same filter of 10 mm nominal diameter. At the forward and latter filters, the primary pressures were respectively 1.5 MPa and 1.2 MPa, and the secondary pressures were respectively 1.0 MPa and 0.8 MPa. The temperature of the polymer solution after the filtration was controlled to 36° C., and stored as the polymer solution 36 in the stainless stock tank 30 whose volume was 2000 L. The anchor blade is provided to a center shaft of the stock tank 30, and the polymer solution 36 was always stirred by the anchor blade at 0.3 m/sec as circumferential velocity. Note that when the enrichment of the polymer solution is made, corrosions of parts or portions contacting to the polymer solution in the devices and devices didn't occur at all. Further, the mixture solvent for preparing the additive liquid contained dichloromethane of 86.5 pts.wt., acetone 13 pts.wt., and n-butanol 0.5 pts.wt.

(4) Discharging

The film is formed in a film manufacturing line 40 shown in FIG. 2. The pumps 46, 47, 48 for increasing the primary pressures were high accuracy gear pumps and driven to feed the polymer solution 36 while the feed back control was made by an inverter motor. Thus the primary pressure of high accuracy gear pump was controlled to 0.8 MPa. As for the pumps 46-48, volumetric efficiency was 99.2%, and the variation rate of the discharging was at most 0.5%. Further, the discharging pressure was 1.5 MPa.

The casting die 71 has the feed block 70 which is 1.8 m in width and adequate for the co-casting, such that not only the main dope (corresponding to the first dope) but also the two dopes (corresponding to the second and third dopes) on both surfaces of the main dope can be cast simultaneously. Thus the produced film has three-layer structure. The polymer solution was fed through the first-third paths 43-45.

(5) Production of Dope

The mixture solvent, the polymer solution 36, UV-absorbing agent A, UV-absorbing agent B, and a retardation controller were mixed. (Herein, the UV-absorbing agent A was 2(2′-hydroxy-3′,5′-di-tert-butylphenyl)benzotriazol, the UV-absorbing agent B was 2(2′-hydroxy-3′,5′-di-tert-amylphenyl)5-chlorobenzotriazol, the retardation controller was N,N′-di-m-tril-N″-p-me-thoxyphenyl-1,3,5-triazine-2,4,6-triamine). Thus, the additive 51 for forming the intermittent layer was obtained in liquid state and stored in the stock tank 50. The pump 52 was driven to feed the additive 51, so as to add the additive 51 to the polymer solution 36 in the first path 43. Thus the additive 51 and the polymer solution 36 were mixed by the static mixer, such that the dope for forming the intermittent layer was obtained.

0.05 pts.mass of silicone dioxide (particle diameter, 15 nm; Mohs Hardness, about 7) as matting agent, and 0.006 pts.wt. of citric acid ester mixture (citric acid, citric acid monoethylester, citric acid diethylester, citric acid triethylester) as peeling agent were dissolved to or dispersed in the polymer solution 36 and the mixture solvent. Thus the additive 56 was obtained in liquid state. The additive 56 was stored in the stock tank 55, and fed out by the pump 57 at the predetermined flow volume to the polymer solution which is flowing in the second path 44. Then the mixture of the additive 56 and the polymer solution 36 is mixed by the static mixer 58 such that the dope for forming the lowermost layer was obtained.

Silicone dioxide was dispersed in the mixture solvent. Thus the additive 61 was obtained in liquid state and stocked in the stock tank 60. The pump 62 was driven to feed the additive 61, so as to add the additive 61 to the polymer solution 36 in the third path 45. Thus the additive 61 and the polymer solution 36 were mixed by the static mixer 63, such that the dope for forming the uppermost layer was obtained.

(6) Casting

The film is designated such that the thickness of each of the uppermost layer, the intermittent layer and lowermost layer in the TAC film might be respectively 4 μm, 73 μm, and 3 μm, and film thickness might be 80 μm. In order to satisfy these conditions, each dope (for forming each of the uppermost, intermittent and lowermost layers) is cast with control of the flow volume thereof. The casting die 71 is provided with the jacket (not shown), and a heat transfer medium is fed into the jacket. In order to control the temperature of the dope to 36° C., the temperature of the heat transfer medium at an entrance of the jacket was 36° C. The temperature of the casting die 71, the feed block 70 and the pipe were kept to 36° C.

The casting die 71 was the coat hunger type, in which heat bolts for adjusting the film thickness were disposed at the pitch of 20 mm. Thus the film thickness (or the thickness of the dopes) are automatically controlled by the heat bolt. A profile of the heat volt can be set corresponding to the flow rate of the high accuracy gear pump, on the basis of the preset program. Thus the feed back control can be made by the control program on the basis of the profile of an infrared ray thickness meter (not shown) disposed in the film production line 40. The control was made such that, with exception of both side edge portions (20 mm each in the widthwise direction of the produced film), the difference of the film thickness between two positions which were 50 mm far from each other might be at most 1 μm, and the largest difference between the minimal values of the film thickness in the widthwise direction might be at most 3 μm/m. Further, the control was made such that the averaged thickness accuracy of each of the uppermost and lowermost layers might be ±2%, that of the intermittent layer might be at most 1%, and the average film thickness might be at most ±1.5%.

In the primary side of the casting die 71, there is a decompression chamber 81. The decompression rate of the decompression chamber was controlled in accordance with the casting speed, such that the pressure difference might occur in the range of one Pa to 5000 Pa between the upstream and downstream sides of the bead of the cast dope above the casting die. Further, an instrument was provided such that the temperature of the decompression chamber 81 might be set to be higher than the condensation temperature of the gas around the casting section. Further, there were labyrinth packings (not shown) in the upstream and downstream sides of the beads. Further, an opening was provided in both edges. Further, an edge suctioning device (not shown) for reducing the disturbance of the bead was provided.

The material of the casting die was the double layer stainless alloy, whose coefficient of thermal expansion was at most 2*10⁻⁵ (° C.⁻¹). In the compulsory corrosion experiment in an electrolyte solution, the corrosion resistance was almost the same as that of SUS316. Further, the material to be used for the casting die had enough corrosion resistance, such that the pitting (or pitting corrosion) might not occur on the gas-liquid interface even if this material were dipped in a mixture liquid of dichloromethane, methanol and water for three months. The finish accuracy of the contact surface of each casting die 71 and feed block 70 was at most 1 μm in surface roughness, and the slit clearance was adjusted to 1.5 mm in straightness. According to an edge of the contact portion of a lip end of the casting die 71, R is at most 50 μm in all of a width. Further, the shearing rate in the casting die is controlled in the range of one to 5000 per second. Further, the WC coating was made on the lip end from the casting die 71 by a melt extrusion method, so as to provide the hardened layer.

In order to prevent the dry and solidification on part of the slit end of the casting die 71, the mixture solvent dissolvable of the solidified dope was supplied to each edge portion of the gas-liquid interface of the slit at 0.5 ml/min. Thus the mixture solvent is supplied to each bead edge. The pulse rate of a pump for supplying the mixture solvent was at most 5%. Further, the decompression chamber 81 was provided for decreasing the pressure in the rear side by 150 Pa. In order to control the temperature of the decompression chamber 81, a jacket (not shown) was provided, and a heat transfer medium whose temperature was controlled at 35° C. was supplied into the jacket. The edge suction rate could be controlled in the range of 1 L/min to 100 L/min, and was adequately controlled in this experiment so as to be in the range of 30 L/min to 40 L/min.

The belt 72 was an endless stainless belt which was 2.1 m in width and 70 m in length. The thickness of the belt 72 was 1.5 mm, and the surface of the belt 72 was polished, such that the surface roughness might be at most 0.05 μm. The material was SUS316, which had enough corrosion resistance and strength. The thickness unevenness of the entire belt 72 was at most 0.5% of the predetermined value. The belt 72 was moved by rotating the back-up rollers 73, 74. At this moment, the tension of the belt 72 was controlled to 1.5*10⁴ kg/m. Further, the relative speed to each roller to the belt 72 changed. However, in this experiment, the control was made such that the difference of the relative speed between the back-up rollers 73, 74 was at most 0.01 m/min. Further the control was made such that the variation of the speed of the belt 72 was at most 0.5% to the predetermined value. The position of the belt in the widthwise direction was controlled with detection of the position of the side end, such that meandering in one circle of the moving belt 72 was reduced in 1.5 mm. Further, below the casting die 71, the variation of the position in the vertical direction between the lip end of the casting die and the belt 72 was in 200 μm. The belt 72 is preferably incorporated in a casting chamber 76 which has air pressure controller (not shown). The three dopes (for forming the uppermost, intermittent and lower most layers) were cast onto the belt 72 from the casting die 71.

In this experiment, the back-up rollers 73, 74 were supplied therein with a heat transfer medium, such that the temperature of the belt 72 might be controlled. The back-up roller 73 disposed in a side of the casting die 71 was supplied with the heat transfer medium (water) at 5° C., and the back-up roller 74 was supplied with the heat transfer medium (water) at 40° C. The surface temperature of the middle portion of the belt 72 at a position just before the casting was 15° C., and the temperature difference between both sides of the belt was at most 6° C. Note that a number of pinhole (diameter, at most 30 μm) was zero, a number of pinhole (diameter, 10 μm to 30μm) was at most one in square meter, and a number of pinhole (diameter, less than 10 μm) was at most two in square meter.

The temperature of the casting chamber 77 controlled to 35° C. by the temperature controlling device 76. The dopes were cast onto the belt 72 to form the casting film 80, and the drying air was fed out as parallel air wind from the air blowers 82, 83, 84. The overall heat transfer coefficient from the drying air to the belt 72 was 24 kcal/(m²·hr·° C.). Above the belt 72, the temperature of the drying air was 135° C. in the upstream side and 140° C. in the downstream side. Further, below the belt 72, the temperature of the drying air was 65° C. The saturation temperature of each air was around −8° C. The oxygen concentration in the drying atmosphere on the belt 72 was kept at 5 vol. %. In order to keep the oxygen concentration at 5 vol. %, the air was substituted by the nitrogen gas. Further, in order to condense and recover the solvent in the casting chamber 76, the condenser 78 was provided, and the temperature of the exit was set to −10° C.

(7) Peeling & Drying

The static pressure fluctuation was controlled in ±1 Pa, such that the drying air was not be directly applied to the dope and the casting film 80 for five second after the casting. When the solvent ratio in the casting film became 150 mass % of dry weight standard, the casting film 80 was peeled as the wet film 87 from the belt 72 with support of the peel roller. At the peeling, the peeling tension was 10 kgf/m. Further, in order to reduce the peeling defect, the peeling speed was adequately controlled such that the percentage thereof to the speed of the belt 72 might be in the range of 100.1% to 110%. The surface temperature of the wet film 87 was 15° C. According to the drying speed, 60 mass % of the solvent in dry weight standard was evaporated per minute in average. The solvent vapor generated in the drying was condensed at −10° C. by the condenser 78, and recovered by the recovering device 79. The recovered solvent was reused after the conditioning thereof. At this moment, the water content in the solvent was at most 0.5%. The air from which the solvent was removed was heated again and reused as the drying air. The wet film 87 was transported toward the tenter device 100 by the rollers in the interval section 90. At this moment, the air blower fed the drying air at 40° C. to the wet film 87. While the wet film 87 was transported in the interval section 90, the tension about 20N was applied to the wet film 87.

In the tenter device 100, both side edge portions of the wet film 87 was held by clips, and then transported in a drying zone for performing the drying. The clip was supplied with a heat transfer medium at 20° C. The drive of the tenter device was made with use of chain, and the speed variation of sprockets of the chain was at most 0.5%. Further, the inside of the tenter device 100 was partitioned into three zones, in which the temperatures of the drying airs were 90° C., 100° C. and 110° C. sequentially from the upstream side. The drying air had composition so as to be saturated at −10° C. According to the drying speed in the tenter device 100, the 120 mass % of the solvent of dry weight standard was evaporated per minute in average. The conditions of the drying zones were adjusted such that the remaining content of the solvent in the film might be 7 mass % at an exit of the tenter device 100. Further, in the tenter device 100, the stretching in the widthwise direction was made as the transportation was made. If the percentage of the film width before the tenter device 100 was determined to 100%, the stretching ratio of the film width after the tenter device 100 was 103%. Further, the film was drawn in the lengthwise direction between the peel roller 86 and the tenter device 100. The drawing ratio in percentage was 102%. According to the stretching ration in the tenter device 100, the difference of the actual stretching ratio was at most 10% between parts which were at least 10 mm apart from the holding positions of the clips, and at most 5% between parts which were 20 mm apart from the holding portions. In the side edge portions in the tenter device 100, the ratio of the length in which the fixation was made was 90%. The solvent vapor generated in the tenter device 100 was condensed at −10° C. to a liquid state and recovered. For the condensation, a condenser (not shown) was provided, and a temperature at an exit thereof was −8° C. The water content in the recovered solvent was regulated to at most 0.5 mass %, and then the recovered solvent was reused. The wet film 87 was fed out as the film 101 from the tenter device 100.

In 30 seconds from exit of the tenter device 100, both side edge portions were slit off in the slitting device 102. In this experiment, each side portion of 50 mm in the widthwise direction of the film 101 was determined as the side edge portion, which were slit off by an NT type slitter of the slitting device 102. The slit side edge portions were sent to the crusher 103 by applying air blow from a blower (not shown), and crushed to tips about 80 mm². The tips were reused as raw material with the TAC frame for the dope production. The oxygen concentration in the drying atmosphere in the tenter device 100 was kept to 5 vol. %. Note that the air was substituted by nitrogen gas in order to keep the oxygen concentration at 5 vol. %. Before the drying at the high temperature in the drying device 105, the pre-heating of the film 101 was made in a pre-heating chamber (not shown in which the air blow at 100° C. was supplied.

The film 101 was dried at high temperature in the drying device 105, which was partitioned into four partitions. Air blows whose temperatures were 120° C., 130° C., 130° C. and 130° C. from the upstream side were fed from air blowers (not shown) to the partitions. The transporting tension of each roller 104 to the film 101 was 100 N/width. The drying was made for ten minutes such that the content of the remaining solvent might be 0.3 mass %. The lapping angle of the roller 4 was 90° and 180°. The rollers 104 were made of aluminum or carbon steel. On the surface, the hard chrome coating was made. The surfaces of the rollers 104 were flat or processed by blast of matting process. The swing of the roller in the rotation was in 50 μm. Further, the bending of the roller 104 at the tension of 100 N/width was reduced to at most 0.5 mm.

The solvent vapor contained in the drying air is removed with use of the adsorbing device 106 in which an adsorbing agent was used. The adsorbing agent was active carbon, and the desorption was performed with use of dried nitrogen. The recovered solvent was reuse as the solvent for the dope preparation after the water content might be at most 0.3 mass %. The drying air contains not only the solvent vapor but also gasses of the plasticizer, UV-absorbing agent, and materials of high boiling points. Therefore, a cooler for removing by cooling and a preadsorber were used to remove them. Thus the drying air was reused. The ad- and desorption condition was set such that a content of VOC (volatile organic compound) in exhaust gas might be at most 10 ppm. Furthermore, in the entire solvent vapor, the solvent content to be recovered by condensation method was 90 mass %, and almost of the remaining solvent vapor was recovered by the adsorption recovering.

The film 101 was transported to a first moisture controlling chamber (not shown). In the interval section between the drying device 105 and the first moisture controlling chamber, the drying air at 110° C. was fed. In the first moisture controlling chamber, the air whose temperature was 50° C. and dewing point was 20° C. was fed. Further, the film 101 was fed into a second moisture chamber (not shown) in which the curling of the film 101 was reduced. An air whose temperature was 90° C. and humidity was 70% was applied to the film 101 in the second moisture controlling chamber.

After the moisture adjustment, the film 101 was cooled to 30° C. in the cooling chamber 107, and then the edge slitting was performed. The compulsory neutralization device (or a neutralization bar) 108 was provided, such that in the transportation, the charged electrostatic potential of the film might be in the range of −3 kV to +3 kV. Further, the film knurling was made on a surface of each side of the film 101 by the knurling roller 109. The width of the knurling was 10 mm, and the knurling pressure was set such that the maximal thickness might be at most 12 μm larger in average than the averaged thickness.

(8) Winding

The film 101 was transported to a winding chamber 110, whose inside temperature and humidity were respectively kept to 28° C. and 70%. Further, a compulsory neutralization device (not shown) was provided, such that the charged electrostatic potential of the film might be in the range of −1.5 kV to +1.5 kV. The obtained film 101 was 1475 mm in width. The diameter of the winding shaft 111 was 169 mm. The tension pattern was set such that the winding tension was 360 N/width at first, and 250 N/width at last. The film 101 was entirely 3940 m in length. The winding cycle was 400 m, and the oscillation width was in ±5 mm. Further, the pressure of the press roller 112 to the winding shaft 111 was set to 50N/width. The temperature of the film at the winding was 25° C., the water content was 1.4 mass %, and the content of the remaining solvent was 0.3 mass %. Through all processes, according to the drying speed, 20 mass % of the solvent in dry weight standard was evaporated per minute in average. Further, the loose winding and wrinkles didn't occur, and the film didn't transit in the film roll even in 10 G impact test. Further, the roll appearance was good.

The film roll of the film 101 is stored in the storing rack of 55% RH for one month. Then the inspection was made in the same way as above, but the remarkable change of the film conditions was not recognized. Further, the adhesion of the film didn't occur in the film roll. After production of the film 101, any part of the casting film 80 formed of the dope was not recognized on the belt 72.

(9) Estimation

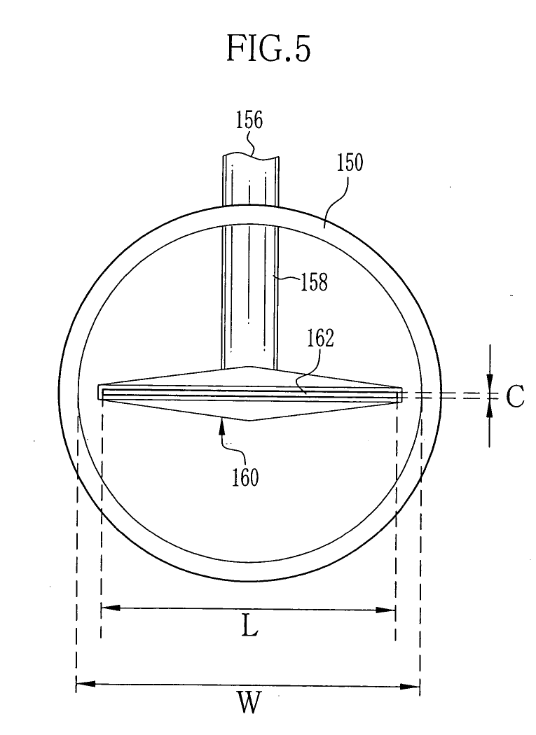

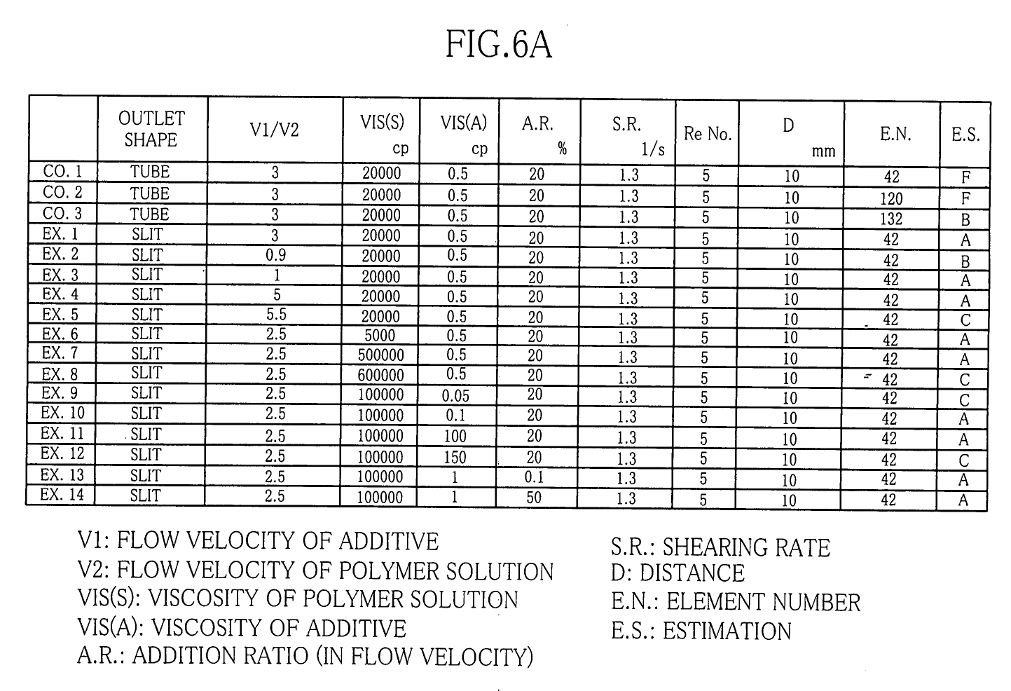

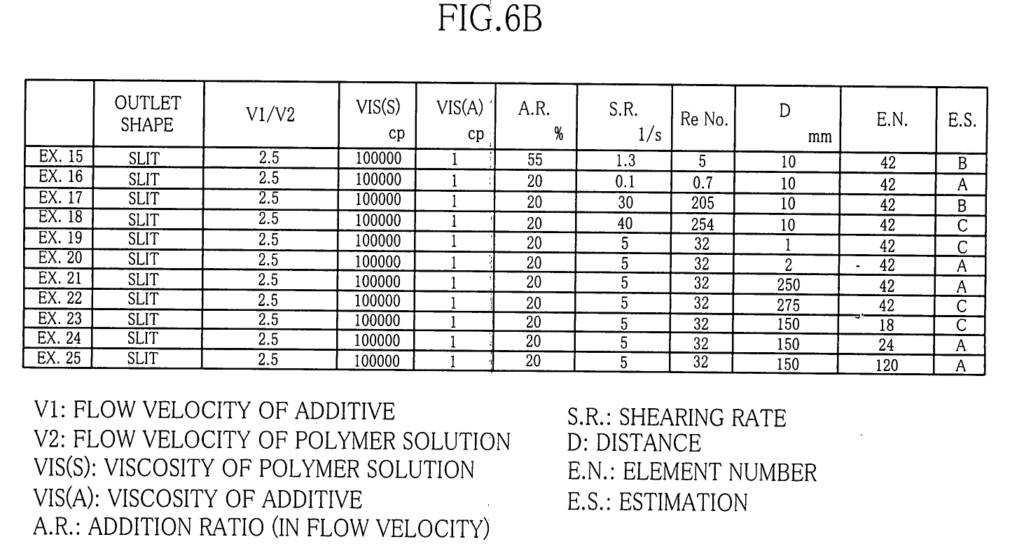

In examples of this experiment, the addition nozzle 160 (see, FIGS. 5 & 6) having the slit 162 was used for the above dope production (5) of the film manufacturing processes. Otherwise, in comparisons of this experiment, a prior addition nozzle having cylindrical tube was used for the dope production process.

Several polymer solutions was produced under different conditions, and the visualization of each polymer solution was made. Then the additives were added, and the stirring was made, such that the dope was obtained. In the estimation, the mixing condition of the dope was observed. Note that the inner diameter W of the pipe 150 for feeding the polymer solution or the dope was 0.055 m. The density of the polymer solution was 1300 kg/m³, and the atmospheric temperature of the processes was 20° C. Further, colorant for visualization was crystal violet.

[Comparison 1 (CO.1)]

The flow velocity ratio V1/V2 between the flow velocity V1 of the additive and the flow velocity V2 of the polymer solution was 3. The viscosity N2 of the polymer solution was 20000 cp, and the viscosity N1 of the additive was 0.5 cp. The addition ratio of the additive, as ratio of the flow velocity, was 20%. The shearing rate V3 of the polymer solution was 1.3 (1/s), and Reynolds Number Re was 5. The distance D between the slit and the static mixer was 10 mm. A number of the elements (hereinafter element number) of the static mixer was 42. According to the dope produced under the conditions, the mixing condition was bad and the coloring unevenness was observed. Therefore the estimation was F (fail).

[Comparisons 2 & 3 (CO.2 & 3)]

In Comparisons 2 & 3, an element number of the static mixer was changed. In Comparison 2, a number of the elements was 120, and in Comparison 3, an element number was 132. Other conditions were the same as in Comparison 1. As the results, according to the dope in Comparison 2, the mixing condition was bad and the coloring unevenness was observed. Therefore the estimation was F (fail). Further, according to the dope in Comparison 3, the mixing condition was relatively good and the coloring unevenness wasn't observed. Therefore the estimation was B (good).

### EXAMPLE 1 (EX. 1)

The flow velocity ratio V1/V2 between the flow velocity V1 of the additive and the flow velocity V2 of the polymer solution was 3. The viscosity N2 of the polymer solution was 20000 cp, and the viscosity N1 of the additive was 0.5 cp. The addition ratio of the additive, as ratio of the flow velocity, was 20%. The shearing rate V3 of the polymer solution was 1.3 (1/s), and Reynolds Number Re was 5. The distance D between the slit and the static mixer was 10 mm. An element number of the static mixer was 42. According to the dope produced under the conditions, the mixing condition was good and the coloring unevenness wasn't bserved. Therefore the estimation was A (excellent).

### EXAMPLES 2-5 (EX. 2-5)

In Examples 2-5, the flow velocity ratio V1/V2 was changed. In Example 2, the flow velocity ratio V1/V2 was 0.9. In Example 3, the flow velocity ratio V1/V2 was 1. In Example 4, the flow velocity ratio V1/V2 was 5. In Example 5, the flow velocity ratio V1/V2 was 5.5. Other conditions were the same as in Example 1. As the results, according to the dope in Example 2, the mixing condition was good and the coloring unevenness wasn't remarkable. Therefore the estimation was B (good). Further, according to the dopes in Examples 3 & 4, the mixing condition was good and the coloring unevenness wasn't observed. Therefore the estimation was A (excellent). According to the dope in Examples 5, the mixing condition was not so good and the coloring unevenness was sometimes observed. Therefore the estimation was C (usable).

### EXAMPLES 6-8 (EX. 6-8)

In Examples 6-8, the flow velocity ratio V1/V2 was 2.5. The viscosity N2 of the polymer solution was changed. In Example 6, the viscosity N2 was 5000 cp. In Example 7, the viscosity N2 was 500000 cp. In Example 8, the viscosity N2 was 600000 cp. Other conditions were the same as in Example 1. As the results, according to the dopes in Example 6 & 7, the mixing condition was good and the coloring unevenness wasn't observed. Therefore the estimation was A (excellent). Further, according to the dope in Examples 8, the mixing condition was not so good and the coloring unevenness was sometimes observed. Therefore the estimation was C (usable).

### EXAMPLES 9-12 (EX. 9-12)

In Examples 9-12, the flow velocity ratio V1/V2 was 2.5, and the viscosity N2 of the polymer solution was 100000 cp. Further, the viscosity N1 was changed. In Example 9, the viscosity N1 was 0.05 cp. In Example 10, the viscosity N1 was 0.1 cp. In Example 11, the viscosity N1 was 100 cp. In Example 12, the viscosity N1 was 150 cp. Other conditions were the same as in Example 1. As the results, according to the dopes in Examples 9 & 12, the mixing condition was not so good and the coloring unevenness was sometimes observed. Therefore the estimation was C (usable). Further, according to the dopes in Examples 10 & 11, the mixing condition was good and the coloring unevenness wasn't observed. Therefore the estimation was A (excellent).

### EXAMPLES 13-15 (EX. 13-15)

In Examples 13-15, the flow velocity ratio V1/V2 was 2.5, the viscosity N2 of the polymer solution was 100000 cp, and the viscosity N1 was one. In Examples 13-15, the addition ratio of the additive was changed. In Example 13, the addition ratio was 0.1%. In Example 14, the addition ratio was 50%. In Example 15, the addition ratio was 55%. Other conditions were the same as in Example 1. As the results, according to the dopes in Examples 13 & 14, the mixing condition was good and the coloring unevenness wasn't observed. Therefore the estimation was A (excellent). Further, according to the dope in Example 15, the mixing condition was good and the coloring unevenness wasn't remarkable. Therefore the estimation was B (good).

### EXAMPLES 16-18 (EX. 16-18)

In Examples 16-18, the flow velocity ratio V1/V2 was 2.5, the viscosity N2 of the polymer solution was 100000 cp, and the viscosity N1 was one. In Examples 16-18, the shearing rate V3 and the Reynolds number were changed. In Example 16, the shearing rate V3 was 0.1 (1/s) and the Reynolds number was 0.7. In Example 17, the shearing rate V3 was 30 (1/s) and the Reynolds number was 205. In Example 18, the shearing rate V3 was 40 (1/s) and the Reynolds number was 254. Other conditions were the same as in Example 1. As the results, according to the dopes in Examples 16, the mixing condition was good and the coloring unevenness wasn't observed. Therefore the estimation was A (excellent). Further, according to the dope in Example 17, the mixing condition was good and the coloring unevenness wasn't remarkable. Therefore the estimation was B (good). According to the dopes in Example 18, the mixing condition was not so good and the pressure loss was a little higher. Therefore the estimation was C (usable).

### EXAMPLES 19-22 (EX. 19-22)

In Examples 19-22, the flow velocity ratio V1/V2 was 2.5, the viscosity N2 of the polymer solution was 100000 cp, and the viscosity N1 was one. The shearing rate V3 was 5 (1/s) and the Reynolds number Re were 32. Other conditions were the same as in Example 1. In Examples 19-22, the distance D between the slit and the static mixer was changed. In Example 19, the distance D was 1 mm. In Example 20, the distance D was 2 mm. In Example 21, the distance D was 205 mm. In Example 22, the distance D was 275 mm. As the results, according to the dope in Example 19, since the addition nozzle was sometimes stopped, the estimation was C (usable). Further, according to the dope in Examples 20 & 21, the mixing condition was good and the coloring unevenness wasn't observed. Therefore the estimation was A (excellent). According to the dope in Example 22, the additive is sometimes not added in a center of the static mixer, and thus the mixing was not made uniformly. Therefore the estimation was C (usable).

### EXAMPLES 23-25 (EX. 21-25)

In Examples 23-25, the distance D between the slit and the static mixer was 150 mm. In Examples 23-25, an element number in the static mixer was changed. Other conditions were the same as in Examples 19-22. In Example 23, an element number was 18. In Example 24, an element number was 24. In Example 25, an element number was 120. As the results, according to the dope in Example 23, the mixing condition was good but the pressure loss was a little higher. Therefore the estimation was C (usable). According to the dopes in Examples 24 & 25, the mixing condition was not so good and the coloring unevenness wasn't observed. Therefore the estimation was A (excellent).

(10) Conclusion

As described above, the additive was added from the slit-like slit which is extended in a diameter direction of the pipe for feeding the polymer solution, and thus it is observed that the additive and the polymer solution were mixed and stirred efficiently. Furthermore, in the above experiment, when several conditions (such as the distance between the addition nozzle and the static mixer, the ratio of the flow rate between the polymer solution and the additive, and the like) were set adequately, the polymer solution and the additive are efficiently mixed and stirred.

Further, In order to effectively stir and mix the polymer solution and the solvent, it can be considered that the polymer solution is treated under the condition of turbulence range that the Reynolds number Re is at least 2000. However, in this case, the pressure loss becomes extremely large. Otherwise, in the present invention, the stirring/mixing was efficiently made even in the laminar flow range that the Reynolds number was at most 100.

Various changes and modifications are possible in the present invention and may be, understood to be within the present invention.

What is claimed is:

1. A method of producing a dope comprising steps of:
dissolving a polymer to a, solvent, so as to obtain a polymer solution;
passing said polymer solution through a pipe;
adding to said polymer solution an additive through a slit disposed in said pipe, said slit extending in a diameter direction of said pipe; and
mixing and stirring a mixture of said polymer solution and said additive by an inline mixer, such that said dope may be obtained.

2. A method as described in claim 1, wherein a length of said slit is in the range of 20% to 80% of an inner diameter of said pipe.

3. A method as described in claim 1, wherein a clearance of said slit is in the range of 0.1 mm to 1/10 of an inner diameter of said pipe.

4. A method as described in claim 1, wherein a distance between said slit and said inline mixer is in the range of 1 mm to 250 mm.

5. A method as described in claim 1, wherein when a flow velocity of said additive is V1 and a flow velocity of said polymer solution is V2, a following condition is satisfied:
1≦V1/V2≦5

6. A method as described in claim 1,
wherein said polymer solution has a viscosity in the range of 5000 cp to 500000 cp at 20° C., a shearing rate V3 of said polymer solution satisfies a condition of 0.1 (1/s)≦V3≦30(1/s), a Reynolds number of said polymer solution is at most 200; and wherein said additive has a viscosity in the range of 0.1 cp to 100 cp.

7. A method as described in claim 1, wherein an addition ratio of said additive is from 0.1% to 50% in flow volume.

8. A solution casting method for producing a polymer film, comprising steps of:
dissolving a polymer to a solvent, so as to obtain a polymer solution;
passing said polymer solution through a pipe;
adding to said polymer solution an additive through a slit disposed in said pipe, said slit extending in a diameter direction of said pipe;
mixing and stirring a mixture of said polymer solution and said additive, such that a dope may be obtained; and
casting said dope on a support, so as to form said polymer film.

9. An apparatus for producing a dope, comprising:
a pipe for passing a polymer solution through which a polymer is dissolved to a solvent;
an addition nozzle disposed in said pipe, for feeding an additive out to said polymer solution, a slit of said addition nozzle extending in a diameter direction of said pipe; and
an inline mixer for mixing said polymer solution and said additive such that said dope may be obtained.

10. An apparatus as described in claim 9, wherein said inline mixer is a static mixer which has an element formed by wrenching a rectangle plate, and a lengthwise direction of said slit is almost perpendicular to an upstream end of said element.
